(19) United States
(12) Patent Application Publication
(10) Pub. No.: US 2010/0049717 A1
(43) Pub. Date: Feb. 25, 2010

(54) METHOD AND SYSTEMS FOR SYCHRONIZATION OF PROCESS CONTROL SERVERS

(76) Inventors: Michael F. Ryan, Stoughton, MA (US); Jeffrey Tai-Sang Tham, Quincy, MA (US); Joel S. Stein, Foxborough, MA (US)

Correspondence Address: ARMSTRONG TEASDALE LLP (14983);PATRICK W. RASCHE, ONE METROPOLITAN SQUARE, SUITE 2600, ST. LOUIS, MO, 63102-2740, US

(21) Appl. No.: 12/195,228

(22) Filed: Aug. 20, 2008

(51) Int. Cl. G06F 17/30; G06F 15/16

(52) U.S. Cl. 707/10; 709/203; 707/E17.005

(57) ABSTRACT

A method for synchronization of data stored in redundant servers of a process control system is described. The redundant servers include an active server and at least one standby server, in communication with a plurality of applications. The method includes generating a memory snapshot of information stored in a plurality of active server memory locations at a predetermined time. The information stored in the plurality of active server memory locations includes application operating data for the plurality of applications and the memory snapshot includes a data structure that includes a copy of the information stored in the plurality of active server memory locations. The method also includes transmitting the memory snapshot from the active server to the at least one standby server, and storing the memory snapshot at the at least one standby server.

### BACKGROUND OF THE INVENTION

The field of the disclosure relates generally to process control systems and, more specifically, to systems and a method for synchronization of data between redundant servers in a process control system.

At least some known process control networks include a plurality of human machine interface (HMI) clients connected to redundant supervisory control and data acquisition (SCADA) servers via Local Area Networks (LAN). One SCADA server is in control as an active server while the at least one other SCADA server is in standby mode. The data between the SCADA servers are synchronized. At least some known process control networks include a plurality of remote terminal units (RTUs) and or process logic controllers (PLCs) connected to a SCADA server via a LAN. The SCADA server analyzes the received data and provides operating instructions to the RTUs/PLCs based on a stored database of desired operating conditions.

Some known process control networks include redundant SCADA servers in order to provide added reliability of operation. One of the problems with redundant schemes is that each SCADA server may not be storing the same operating data, for example, due to user updates provided to the active SCADA server but not to the backup server. In the event of a failure, using the backup SCADA server may lead to process control based on out-of-date stored operating data.

### BRIEF DESCRIPTION OF THE INVENTION

In one aspect, a method for synchronization of data stored in redundant servers of a process control system is provided. The redundant servers include an active server and at least one standby server in communication with a plurality of applications. The method includes generating a memory snapshot of information stored in a plurality of active server memory locations at a predetermined time. The information stored in the plurality of active server memory locations includes application operating data for the plurality of applications and the memory snapshot includes a data structure that includes a copy of the information stored in the plurality of active server memory locations. The method also includes transmitting the memory snapshot from the active server to the at least one standby server, and storing the memory snapshot at the at least one standby server.

In another aspect, a process control server system is provided. The process control server system includes a plurality of human machine interface (HMIs) clients communicatively coupled to a network. The server system also includes a first server communicatively coupled to the network. The first server is configured to operate as a standby server on the network. The first server includes a standby memory for storing information in a plurality of memory locations, wherein the memory locations are configured to store application operating information. The server system also includes a second server communicatively coupled to the network. The second server includes an active memory. The second server is configured to operate as an active server on the network and to store application operating information in a plurality of memory locations within the active memory. The second server is also configured to generate a memory snapshot of the information stored in the plurality of memory locations. The memory snapshot includes a copy of the information stored in the plurality of memory locations at a predetermined time. The second server is also configured to transmit the memory snapshot to the first server to synchronize the standby memory and the active memory.

In yet another aspect, a process control server is provided. The process control server is configured to communicate over a network with at least one human machine interface (HMI) client, to operate as an active server on the network, and to store application operating information for a plurality of applications in a plurality of active server memory locations. The process control server is also configured to generate a memory snapshot of the application operating information, wherein the memory snapshot includes a copy of the information stored in the plurality of active server memory locations at a predetermined time. The process control server is also configured to transmit the memory snapshot to at least one standby server to synchronize information stored in a plurality of standby server memory locations and the information stored in the plurality of active server memory locations.

### BRIEF DESCRIPTION OF THE DRAWINGS

FIG. 1 is a schematic diagram of an exemplary process control server system.

FIG. 2 is a flowchart of an exemplary method for synchronization of data stored in redundant servers of a process control system.

### DETAILED DESCRIPTION OF THE INVENTION

The following detailed description illustrates embodiments of the invention by way of example and not by way of limitation. It is contemplated that the invention has general application to redundant control systems in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

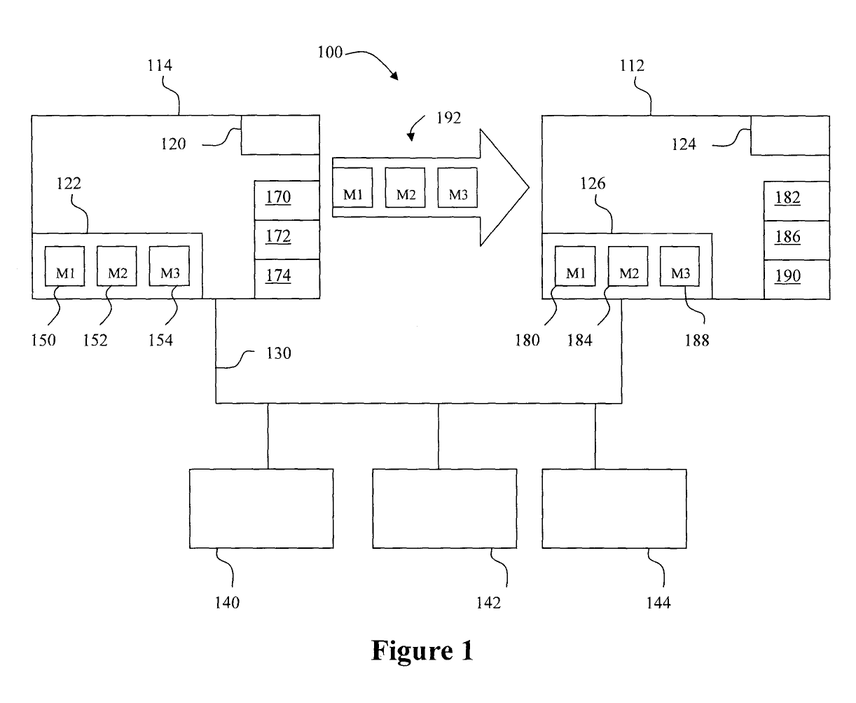

FIG. 1 is a schematic block diagram of an exemplary process control server system 100. In the exemplary embodiment, process control server system 100 includes a first server 112 and a second server 114. The first server 112 is configured to operate as a standby server within system 100 and will be referred to herein as the standby server 112. The second server 114 is configured to operate as an active server within server system 100 and will be referred to herein as the active server 114. Although illustrated as including active server 114 and standby server 112, server system 100 may include any number of standby servers that function as described herein. Active server 114 includes a processor 120 and a memory 122. Similarly, standby server 112 includes a processor 124 and a memory 126. In the exemplary embodiment, servers 112 and 114 are supervisory control and data acquisition (SCADA) servers, however, servers 112 and 114 may be any type of server that allows server system 100 to function as described herein.

In the exemplary embodiment, active server 114 and standby server 112 are coupled via a network 130. Network 130 also couples multiple Human Machine Interfaces (HMIs) to server system 100. In the exemplary embodiment, a first HMI 140, a second HMI 142, and a third HMI 144 are coupled to network 130. HMIs 140, 142, and 144 display data from active server 114 to an operator. HMIs 140, 142, and 144 also facilitate sending data to active server 114 that is entered by the operator. In an exemplary embodiment, the data sent by active server 114 to HMIs 140, 142, and 144 is based on data stored in memory 122 and operating information received by active server 114.

Memory 122 includes a plurality of memory locations, for example, memory locations 150, 152, and 154. In the exemplary embodiment, memory locations 150, 152, and 154 store real-time databases and other application data that may include operating instructions for each of HMIs 140, 142, and 144. The operating instructions may include, but are not limited to including, process instructions, alarm information, and driver information. The data stored in memory locations 150, 152, and 154 may be updated by an operator via active server 114, standby server 112, HMIs 140, 142, 144, or any other input device that allows data to be modified or entered into memory locations 150, 152, and 154.

In some examples, the data stored in memory location 150 is used by an application 170, the data stored in memory location 152 is used by an application 172, and the data stored in memory location 154 includes desired operating characteristics for an application 174.

In the exemplary embodiment, standby server 112 is a redundant server that facilitates substantially uninterrupted operation of server system 100 in the case of a failure of active server 114. In the case of a failure of active server 114, standby server 112 becomes the active server of server system 100. Data stored in memory 126 of standby server 112 includes a memory location 180 which may be used by an application 182. Data stored in memory location 184 may be used by an application 186, and data stored in memory location 188 may be used by application 190. In the exemplary embodiment, application 182 is substantially identical to application 170, other than application 182 is included within standby server 112 and application 170 is included within active server 114. Similarly, application 186 is substantially identical to application 172, and application 190 is substantially identical to application 174.

In order for server system 100 to provide substantially uninterrupted operation, it would be advantageous for standby server memory 126 to include substantially identical data as active server memory 122. More specifically, it would be advantageous for memory location 180 to include substantially identical data as memory location 150, memory location 184 to include substantially identical data as memory location 152, and memory location 188 to include substantially identical data as memory location 154.

In order to facilitate synchronization of memories 122 and 126, active server 114 generates a memory snapshot of information stored in memory locations 150, 152, and 154. In the exemplary embodiment, the memory snapshot is a data structure that contains a copy of the information stored in each of memory locations 150, 152, and 154. Since the information stored in memory locations 150, 152, and 154 is variable, (e.g., may be edited by an operator), the memory snapshot includes the information stored in memory locations 150, 152, and 154 at a predetermined time or at a time associated with an occurrence of an event.

In the exemplary embodiment, active server 114 converts the memory snapshot into network packets for transmission to standby server 112 via network 130. In some other embodiments, the network packets are transferred to standby server 112 via a separate network 192 than network 130. The network packets are received at standby server 112 and reassembled into a copy of the memory snapshot, substantially identical to the memory snapshot sent from active server 114. In the exemplary embodiment, user datagram protocol (UDP) is used as the protocol for network packet transmission. In some other embodiments, the Internet Protocol Suite (TCP/IP) is used, however, any other protocol for transmitting data over a network may be used.

In some embodiments, standby server 112 performs a verification of the network packets received from active server 114 to ensure the integrity of the memory snapshot received at standby server 112. Standby server 112 extracts the operating instructions for each of applications 182, 186, and 190 from the memory snapshot. The extracted operating instructions are then stored in memory locations 180, 184, and 188. In the exemplary embodiment, memory location 180 stores information substantially similar to the information stored in memory location 150 at the time the memory snapshot was generated, memory location 184 stores information substantially similar to the information stored in memory location 152 at the time the memory snapshot was generated, and memory location 188 stores information substantially similar to the information stored in memory location 154 at the time the memory snapshot was generated.

In the exemplary embodiment, memory snapshots are generated at predetermined intervals of time or at the time of an occurrence of an event. To facilitate substantially continuous synchronization of memory locations 150, 152, 154, 180, 184, and 188, in some embodiments, a memory snapshot is generated once every fifty milliseconds. In other examples, a memory snapshot is generated between once every five milliseconds to once every ten seconds. The above described time intervals are provided as examples only, and any time interval may be used that enables server system 100 to function as described herein. In some examples, memory snapshots are generated at times indicated by an operator of process control server system 100.

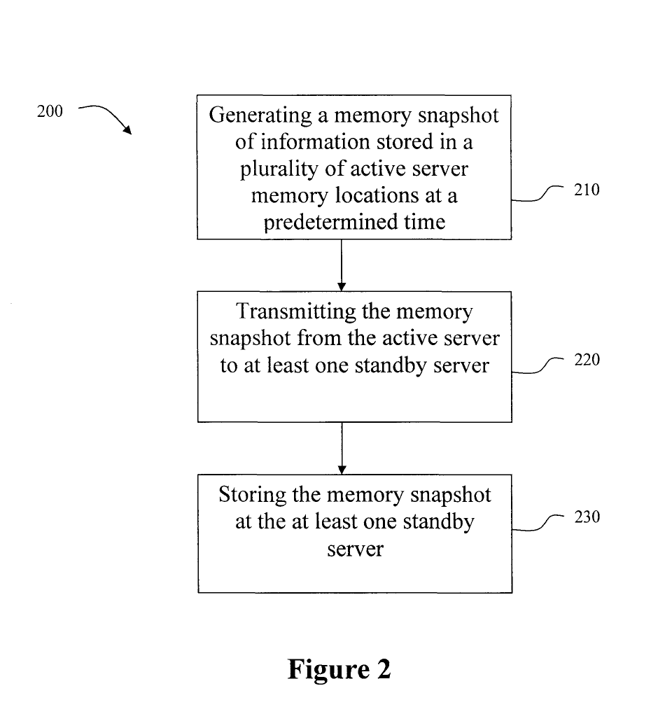

FIG. 2 is a flowchart 200 of an exemplary method for synchronization of information stored in redundant servers of a process control system, for example, servers 112 and 114 of server system 100 (shown in FIG. 1). The exemplary method includes generating 210 a memory snapshot of information stored in a plurality of memory locations of an active server at a predetermined time or at predetermined intervals of time. The information stored in the plurality of active server memory locations may include real-time databases, alarm information, and other application operating data for a plurality of applications, for example, applications 170, 172, and 174 (shown in FIG. 1). Generating 210 includes recording a copy of the information stored in the active server memory locations at a predetermined time. For example, generating 210 includes recording at least one of process data, alarm data, and driver data for a first application of a plurality of applications, and recording at least one of process data, alarm data, and driver data for a second application of the plurality of applications.

Generating 210 a memory snapshot of the plurality of memory locations of an active server at a predetermined time may include recording the memory snapshot at predetermined intervals of time. For example, the memory snapshot may be generated in the range of from once every five milliseconds to once every ten seconds. However, the memory snapshot may be generated at any time interval that allows operation of the redundant servers as described herein. In some examples, the memory snapshot is generated at the time of an occurrence of an event. Once the active server receives an indication of the occurrence of the event, the memory snapshot is generated.

The exemplary method also includes transmitting 220 the memory snapshot from the active server to at least one standby server. In the exemplary embodiment, transmitting 220 includes converting the memory snapshot into network packets for transmission. Converting the memory snapshot into network packets for transmission includes determining a network type coupling the active server to the standby server and matching at least one of a network protocol and a packet size to the network type. For example, if the active server 114 and the standby server 112 are coupled to a network 130 that is able to transmit thirty-two bit packets, active server 114 is configured to convert the memory snapshot into thirty-two bit packets. In another example, network 130 may be able to transmit sixty-four kilobyte packets and active server 114 converts the memory snapshot into sixty-four kilobyte packets for transmission to standby server 112.

The exemplary method also includes storing 230 the memory snapshot at the at least one standby server. Storing 230 includes receiving the network packets at the at least one standby server and reassembling the memory snapshot from the network packets at the at least one standby server. Storing 230 also includes extracting the application operating data for the plurality of applications from the memory snapshot and storing the application operating data in the appropriate memory locations. In some exemplary embodiments, reassembling the memory snapshot from the network packets at the at least one standby server further comprises verifying the integrity of the received memory snapshot.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 120 and 124 including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware, or any combination or subset thereof, wherein the technical effect is synchronizing the data stored in an active server database and at least one standby server database to facilitate substantially uninterrupted operation of a process control system, wherein the substantially uninterrupted operation includes operating a standby server that includes up-to-date application operating information. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and systems for synchronization of redundant servers in a process control system provides a cost-effective and reliable means for facilitating substantially uninterrupted operation of the process control system, even in the event of an active server failure. More specifically, the method and systems described herein facilitate ensuring that the standby server includes substantially the same data as the data stored in the active server at the time of the failure. Furthermore, the method and systems described herein facilitate ensuring minimal disruption in the operation of the applications controlled by the process control system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for synchronization of data stored in redundant servers of a process control system, the redundant servers including an active server and at least one standby server in communication with a plurality of applications, said method comprising:
generating a memory snapshot of information stored in a plurality of active server memory locations at a predetermined time, wherein the information stored in the plurality of active server memory locations comprises application operating data for the plurality of applications, and wherein the memory snapshot comprises a data structure that includes a copy of the information stored in the plurality of active server memory locations;
transmitting the memory snapshot from the active server to the at least one standby server; and
storing the memory snapshot at the at least one standby server.

2. A method in accordance with claim 1, wherein storing the memory snapshot at the at least one standby server further comprises extracting the application operating data for the plurality of applications from the memory snapshot at the at least one standby server.

3. A method in accordance with claim 1, wherein generating a memory snapshot comprises recording the application operating information stored in the active server memory locations at the predetermined time.

4. A method in accordance with claim 3, wherein recording application operating information comprises:
recording at least one of process data, alarm data, and driver data for a first application of the plurality of applications; and
recording at least one of process data, alarm data, and driver data for a second application of the plurality of applications.

5. A method in accordance with claim 1, wherein generating the memory snapshot at the predetermined time comprises recording the memory snapshot at one or more of predetermined intervals of time and at a time that corresponds to an occurrence of an event.

6. A method in accordance with claim 5, wherein generating the memory snapshot at predetermined intervals of time comprises generating the memory snapshot in the range of from once every ten milliseconds to once every ten seconds.

7. A method in accordance with claim 1, wherein transmitting the memory snapshot from the active server to at least one standby server comprises:
converting the memory snapshot into network packets for transmission;
transmitting the network packets from the active server to the at least one standby server;
receiving the network packets at the at least one standby server; and
reassembling the memory snapshot from the network packets at the at least one standby server.

8. A method in accordance with claim 7, wherein converting the memory snapshot into network packets for transmission comprises:
determining a network type coupling the active server and the at least one standby server; and
matching at least one of a network protocol and a packet size to the network type.

9. A method in accordance with claim 7, wherein reassembling the memory snapshot from the network packets at the at least one standby server further comprises verifying the integrity of the received memory snapshot.

10. A process control server system comprising:
a plurality of human machine interface (HMIs) clients communicatively coupled to a network;
a first server communicatively coupled to the network, said first server configured to operate as a standby server on the network, said first server comprising a standby memory for storing information in a plurality of memory locations, said memory locations configured to store application operating information; and
a second server communicatively coupled to the network, said second server comprising an active memory, said second server configured to:
operate as an active server on the network;
store application operating information in a plurality of memory locations within said active memory;
generate a memory snapshot of the information stored in said plurality of memory locations, wherein said memory snapshot comprises a copy of the information stored in said plurality of memory locations at a predetermined time; and
transmit said memory snapshot to said first server to synchronize said standby memory and said active memory.

11. A system in accordance with claim 10, wherein said second server is further configured to convert said memory snapshot into network packets for transmission.

12. A system in accordance with claim 11, wherein said second server is further configured to:
determine a network type coupling said second server to said first server; and
match at least one of a network protocol and a packet size to the network type.

13. A system in accordance with claim 11, wherein said first server is configured to:
receive the network packets; and
reassemble said memory snapshot from the network packets.

14. A system in accordance with claim 13, wherein said first server is further configured to verify the integrity of said received memory snapshot.

15. A system in accordance with claim 13, wherein said first server is further configured to extract the application operating information for the plurality of applications from said received memory snapshot.

16. A system in accordance with claim 10, wherein said second server is further configured to:
record at least one of process data, alarm data, and driver data for a first application of said at least one facility application; and
record at least one of process data, alarm data, and driver data for a second application of said at least one facility application.

17. A system in accordance with claim 10, wherein said second server is further configured to generate the memory snapshot at predetermined intervals of time.

18. A system in accordance with claim 17, wherein the predetermined intervals of time comprises generating the memory snapshot from a range of from ten times per millisecond to generating the memory snapshot once every ten seconds.

19. A process control server configured to:
communicate over a network with at least one human machine interface (HMI) client;
operate as an active server on the network;
store application operating information for a plurality of applications in a plurality of active server memory locations;
generate a memory snapshot of said application operating information, wherein said memory snapshot comprises a copy of the information stored in the plurality of active server memory locations at a predetermined time; and
transmit said memory snapshot to at least one standby server to synchronize information stored in a plurality of standby server memory locations and said information stored in said plurality of active server memory locations.

20. A process control server in accordance with claim 19, further configured to convert the memory snapshot into network packets for transmission.
